(19) United States
(12) Patent Application Publication
(10) Pub. No.: US 2006/0044417 A1
(43) Pub. Date: Mar. 2, 2006

(54) Image pickup apparatus and image pickup method

(75) Inventors: Kei Tashiro, Ome-shi (JP); Tatsuro Abe, Ome-shi (JP); Tatsuhiko Ikehata, Ome-shi (JP); Shiro Nagaoka, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/213,952

(22) Filed: Aug. 30, 2005

(30) Foreign Application Priority Data
Aug. 31, 2004 (JP) 2004-252712

(51) Int. Cl. H04N 5/76

(52) U.S. Cl. 348/231.3

(57) ABSTRACT

An image pickup apparatus has a preparation unit configured to photograph an object, and to prepare an image file with a preparation date and time in accordance with image information of the object, a recording unit configured to have a recording region, and a control unit configured to control so as to detect a preparation date and time of an image folder prepared within the recording region, to newly prepare an image folder within the recording region of the recording unit when a period from a preparation date and time T1 of the image file to a preparation date and time T2 of the image folder is longer than a date and time interval (Cf. one day, one week, one month, or the like) set in advance, and to store the image file prepared at the preparation unit under the folder.

### CROSS-REFERENCE TO RELATED APPLICATIONS

This application is based upon and claims the benefit of priority from prior Japanese Patent Application No. 2004-252712, filed Aug. 31, 2004, the entire contents of which are incorporated herein by reference.

### BACKGROUND OF THE INVENTION

1. Field of the Invention

The present invention relates to an image pickup apparatus and an image pickup method which prepare an image folder for storing an image file in accordance with date and time information of the image file.

2. Description of the Related Art

A digital camera configures a file and a folder in accordance with DCF (Design rule for Camera File system) standard issued by JEITA (Japan Electronics and Information Technology Industries Association). In the standards, there are rules of folder names and file names of digital cameras, and files and folders are respectively managed on the basis of the figures from 0001 to 9999 and from 100 to 999.

Normally, at the time of photographing, a folder of number 100 is prepared when there is no folder in a storage medium, and an image file of number 0001 is stored in the folder. When the photographing is continued, a file number of the next image is made to be the image file number which has been photographed last time+1, and the image is stored in the folder of number 100. When the photographing is successively carried out, images are stored in the same folder until an image number becomes over 9999.

Because there are limits to a folder name and a file name in the DCF standards, it is difficult to manage images and folders on the basis of the names thereof, and therefore, an aggregate of related images (hereinafter, described as a scene) is generally managed so as to separate folders. Namely, a folder is newly prepared at an end of a scene, and a new scene is stored in another folder. With respect to such a folder, a user may arbitrarily prepare a new folder. Moreover, it has bee known that an image folder is prepared in accordance with each date.

In Patent Document 1 (Jpn. Pat. Appln. KOKAI Publication No. 2001-054041), there is disclosed a digital camera apparatus in which a folder is prepared in accordance with a preparation date and time, and image files can be distinguished in accordance with a day.

However, in the prior art described above, although the technology in which a folder is prepared in accordance with a day, one folder per day is not necessarily appropriate. Because an image folder cannot be prepared appropriately in accordance with a use situation, there is a defect that too many image folders are prepared, unnecessary image folders are prepared, and the like.

### BRIEF SUMMARY OF THE INVENTION

One of embodiments is an image pickup apparatus comprising: a preparation unit configured to photograph an object, and to prepare an image file with a preparation date and time in accordance with image information of the object; a recording unit configured to have a recording region; and a control unit configured to control so as to: detect a preparation date and time of an image folder prepared within the recording region; newly prepare an image folder within the recording region of the recording unit when a period from the preparation date and time of the image file to the preparation date and time of the image folder is longer than a date and time interval set in advance; and store the image file prepared at the preparation unit under the folder.

### BRIEF DESCRIPTION OF THE SEVERAL VIEWS OF THE DRAWING

FIG. 1 is a block diagram showing one example of a configuration of an image pickup apparatus according to an embodiment of the invention;

FIG. 2 is a schematic diagram showing one example of an outline of the image pickup apparatus according to the embodiment of the invention;

FIG. 3 is an explanatory diagram showing one example of a file configuration of image folders and image files of the image pickup apparatus according to the embodiment of the invention;

FIG. 4 is an explanatory diagram showing one example of a file configuration of image folders and image files of the image pickup apparatus according to the embodiment of the invention;

FIG. 5 is an explanatory diagram showing one example of a file configuration of image folders and image files of the image pickup apparatus according to the embodiment of the invention;

FIG. 6 is a flowchart showing one example of a method for preparing image folders of the image pickup apparatus according to the embodiment of the invention;

FIG. 7 is an explanatory diagram showing one example of a screen, on which date and time ranges at the time of preparing an image folder are set, of the image pickup apparatus according to the embodiment of the invention;

FIG. 8 is an explanatory diagram showing one example of a screen, on which date and time intervals at the time of preparing an image folder are set, of the image pickup apparatus according to the embodiment of the invention;

FIG. 9 is a flowchart showing one example of a method for preparing image folders of the image pickup apparatus according to the embodiment of the invention;

FIG. 10 is a flowchart showing one example of a method for preparing image folders of the image pickup apparatus according to the embodiment of the invention;

FIG. 11 is a flowchart showing one example of a method for preparing image folders of the image pickup apparatus according to the embodiment of the invention; and

FIG. 12 is a flowchart showing one example of a method for preparing image folders of the image pickup apparatus according to the embodiment of the invention.

### DETAILED DESCRIPTION OF THE INVENTION

Hereinafter, an embodiment of the present invention will be described in detail with reference to the drawings.

<Configuration and Operations of Image Pickup Apparatus According to the Invention>

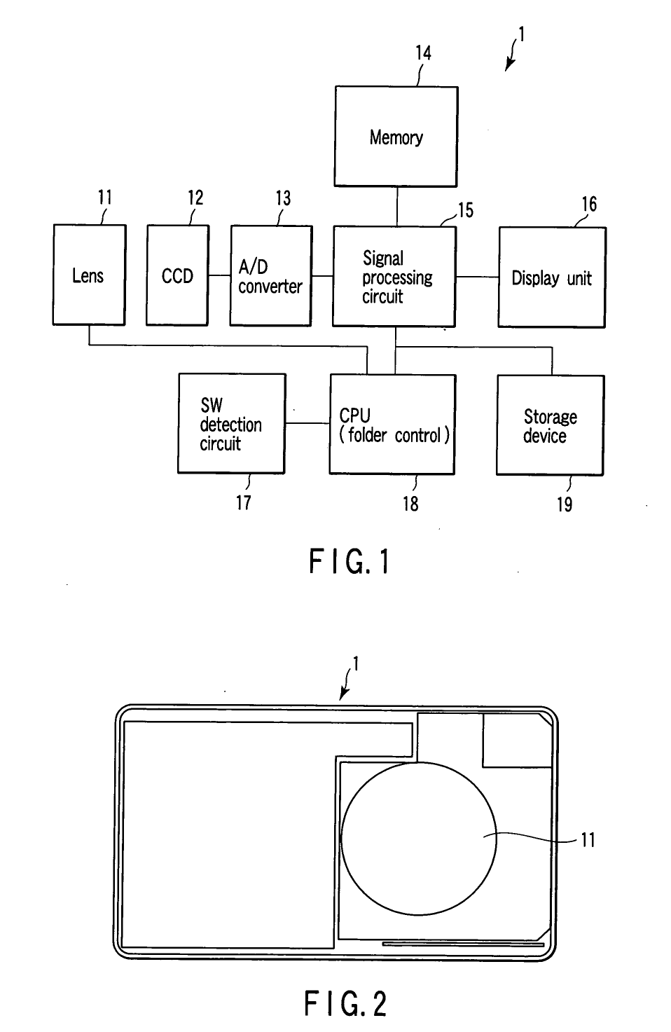

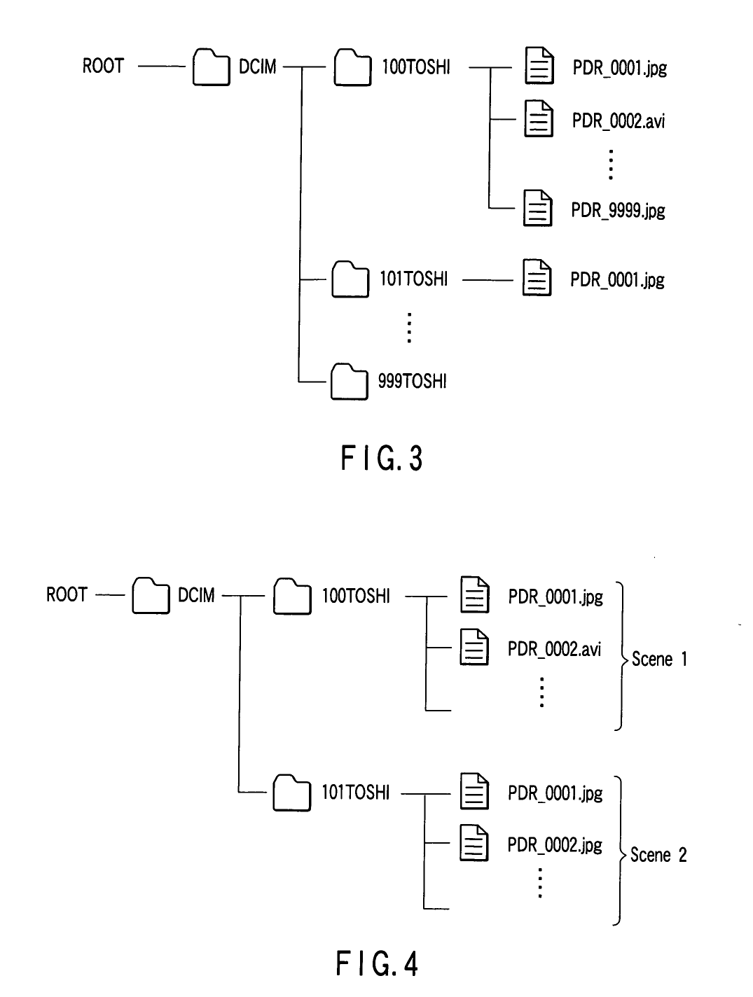

First, the configuration and the operations of an image pickup apparatus (for example, a digital still camera (which may have a moving image processing function) according to the invention will be described in detail with reference to the drawings. FIG. 1 is a block diagram showing one example of the configuration of the image pickup apparatus according to the embodiment of the invention, FIG. 2 is a schematic diagram showing one example of the outline thereof, and FIGS. 3 to 5 are explanatory diagrams showing examples of file configurations of image folders and image files thereof.

An image pickup apparatus 1 (as an example, a digital still camera) according to the invention, as shown in FIGS. 1 and 2, comprises: a lens 11 which receives an image-pickup light from an object; a CCD 12 which receives an imaged light formed as an image on the lens 11; an A/D converter 13 which receives electric information outputted from the CCD 12 in accordance with the imaged light; a signal processing circuit 15 which receives an output signal (image data) from the A/D converter 13 and carries out image processing; and a detachable memory 14 (or may be a memory which is not detachable) which once stores the image data onto which image processing has been applied, via an interface. Moreover, the image pickup apparatus 1 has a CPU 18 which is connected to respective units, and which carries out control of the entire operations and folder control such as a preparation of an image folder which will be described later. The image pickup apparatus 1 further has: a storage device 19 such as, for example, a hard disk or a mass storage memory, which stores image data stored in the memory 14 so as to be made image files; and a display unit 16, such as a liquid crystal screen, which displays an image corresponding to an image file stored in the memory 14 or the storage device 19, and operates those by the control of the CPU 18 in accordance with a signal from operational switches such as a shutter and a mode switch, or a detection circuit 17 such as an optical sensor.

Namely, the thus configured image pickup apparatus 1 according to the invention, under the control of the CPU 18, receives an image-pickup light from an object via the lens 11, converts image data outputted form the CCD 12 corresponding to an image formed on the lens 11 by the A/D converter 13, appropriately applies image processing onto the converted image data in the signal processing circuit 15, and stores the data once in the memory 14 or the like. Thereafter, as needed, the image pickup apparatus 1 prepares an image folder in the memory 14 or the storage device 19, and makes the image data be an image file to be stored, as will be described later. Moreover, the image pickup apparatus 1 displays an image corresponding to the image file on the display unit 16 such as a liquid crystal screen in accordance with an operation.

Further, here, to describe the relationship between a plurality of image files and a plurality of image folders by using FIGS. 3 to 5, as shown in FIG. 3, PDR_{—}0001.jpg through PDR_{—}9999.jpg which are the plurality of image files are, as an example, respectively stored in one of image folders 100TOSHI through 999TOSHI. Here, as shown in FIG. 4, if those are separated into different folders 100TOSHI and 101TOSHI in accordance with, for example, each scene, the management for a user is easy and convenient.

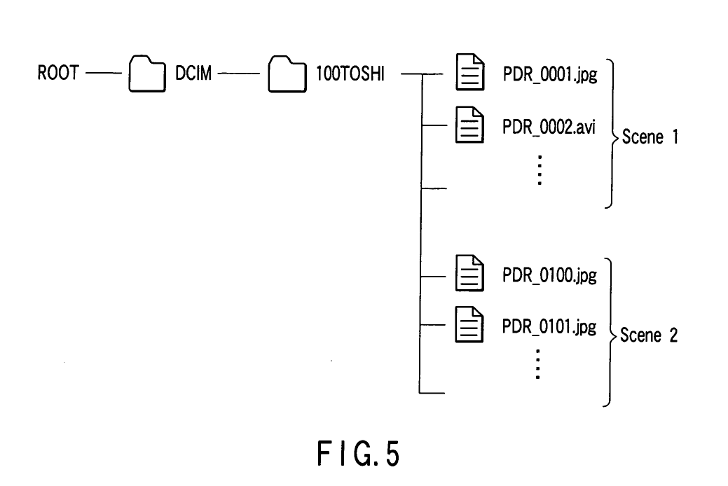

Furthermore, as shown in FIG. 5, as an example, the image files divided into the plurality of image folders can be managed so as to be put together in one image folder 100 for convenience of a user. However, because it is a burden on the user that all of such movements of the image folders and image files, and operations of the management are carried out one by one manually by a user, provided that a preparation of an image folder and a storage of an image file are automatically achieved in accordance with a use situation, a burden on the user is greatly reduced.

<Image Folder Preparation Processing of Image Pickup Apparatus According to the Invention>

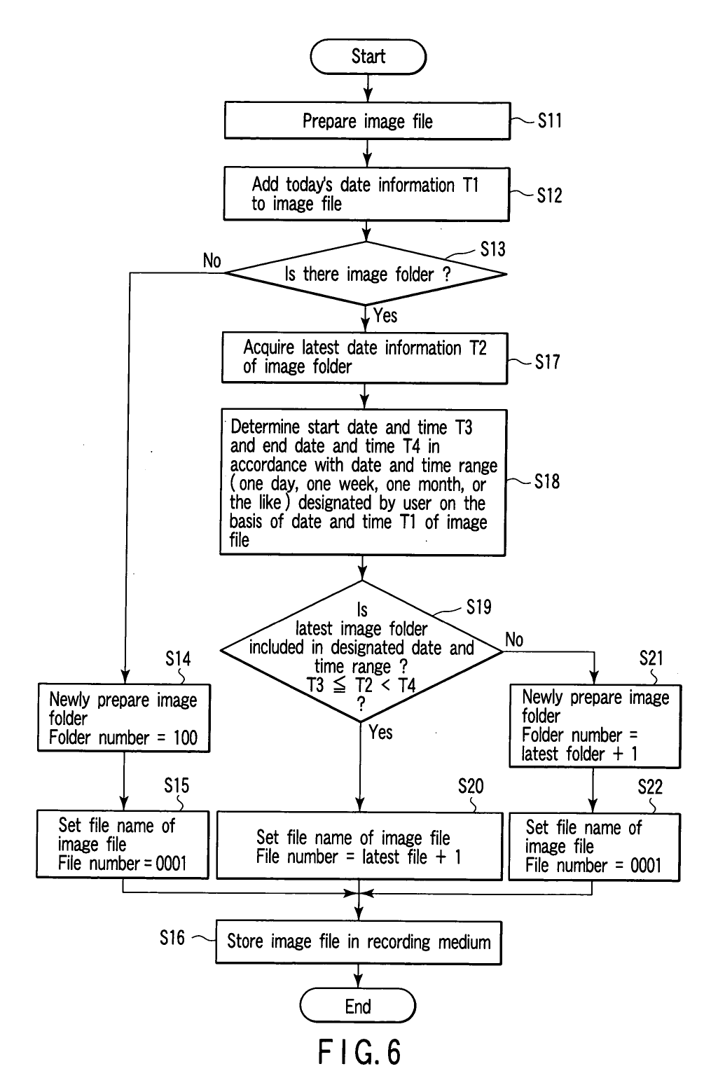

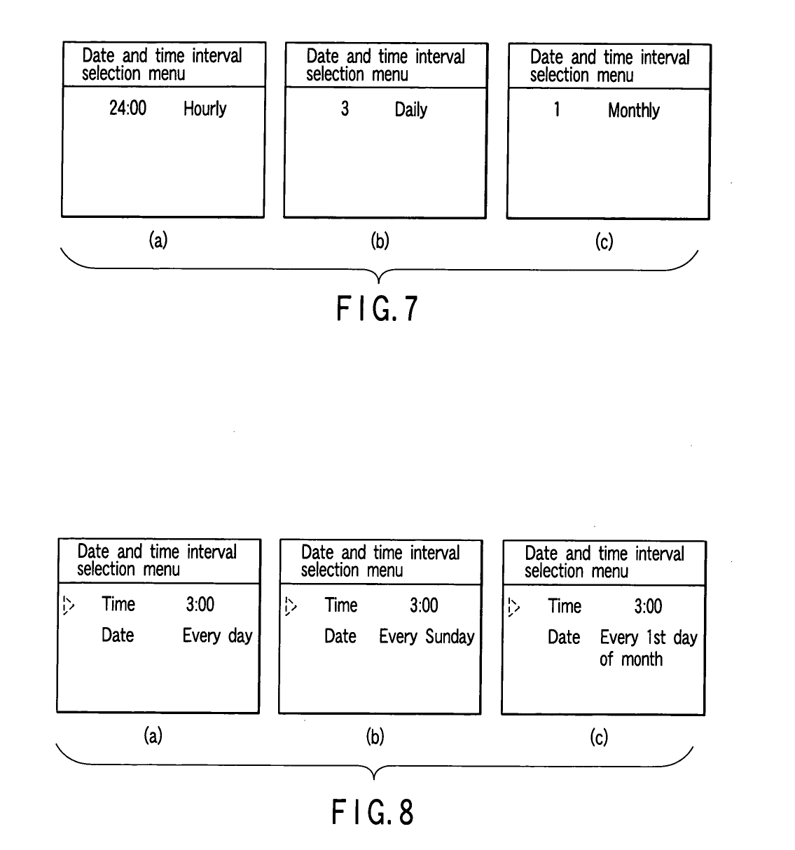

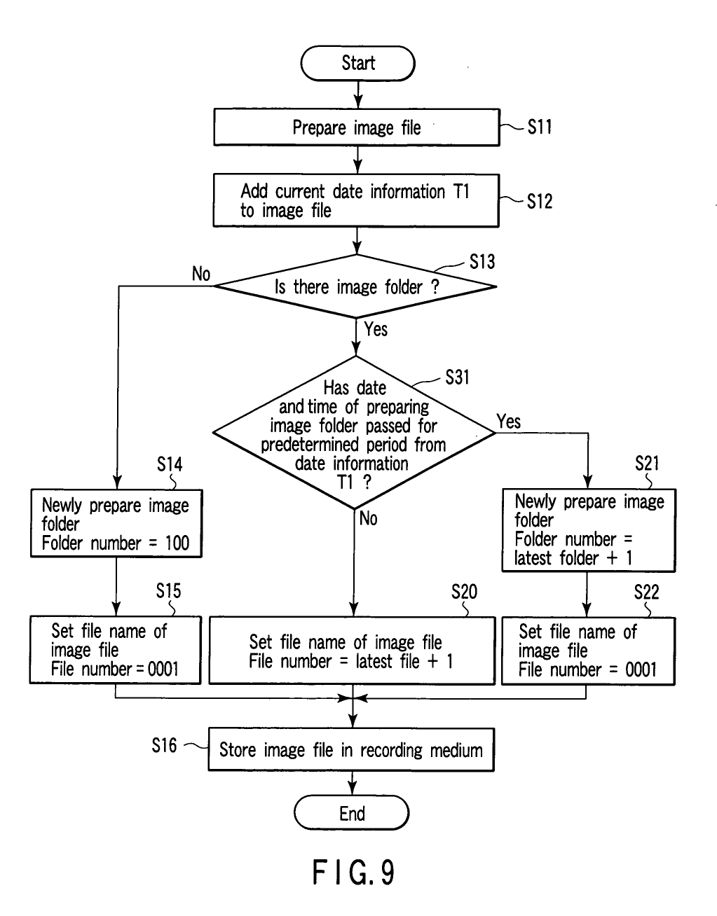

Next, image folder preparation processing which is a feature of the present invention will be described in detail hereinafter by using the drawings. FIG. 6 is a flowchart showing one example of a method for preparing image folders of the image pickup apparatus according to the embodiment of the invention, FIG. 7 is an explanatory diagram showing one example of a screen thereof, on which date and time ranges at the time of preparing an image folder are set, FIG. 8 is an explanatory diagram showing one example of a screen thereof, on which date and time intervals at the time of preparing an image folder are set, FIGS. 9 to 12 are flowcharts showing examples of a method for preparing image folders thereof.

(Comparison of Set Date and Time Range and Preparation Date and Time of Image Folder: FIG. 6)

In the image pickup apparatus 1 according to the invention, as an image folder managing function of the CPU 18, image folders are automatically prepared, and a plurality of image files are appropriately classified into and managed in the image folder. Namely, in the flowchart of FIG. 6, the image folders and the image files are, as an example, in accordance with the DCF standards, and as the image folders, folders for storing images which are managed on the basis of three-digit figures such as 100TOSHI and 101TOSHI as shown in FIGS. 1 to 3 have been known. However, the embodiment of the invention is not limited thereto. Under the control of the CPU 18, image data corresponding to an image formed on the lens 11 is made to be an image file, and is stored in, for example, the memory 14 (S11), and at that time, date information T1 is added to the header part of the image file (S12). Thereafter, it is determined whether or not there is an image folder in the memory 14 (or the storage device 19) (S13). For example, when there is no image folder, a folder of folder number 100 is newly prepared (S14), a file number of the image file is named 0001 (Sl5), and the image file is stored in the new image folder in the memory 14 (or the storage device 19) (S16).

However, when there is an image folder already (S13), a date and time T2 of preparing the image folder is acquired (S17). Moreover, a start date and time T3 and an end date and time T4 are determined in accordance with a date and time range (one day, one week, one month, or the like) designated by the user on the basis of the date and time information T1 of the image file (S18). Here, the date and time range can be arbitrarily set by the user, for example, on a date and time interval selection menu shown in FIG. 7. Then, it is determined whether or not the latest one among the existing image folders is included in the date and time range designated here (S19). Namely, it is determined whether or not T3≦T2<T4.

Here, when the latest one among the existing image folders is included in the designated date and time range, there is no need to prepare a new image folder, and the file name of the image file is set to be a file number=the latest file+1 (S20), and the image file is stored in the image folder of the recording medium (S16).

However, when the existing latest image folder is too old, which is not included in the designated date and time range, a new image folder is automatically prepared without waiting for an instruction of the user, and for example, a new image folder is prepared so as to set to be a folder number=the latest folder+1 (S21). Then, the file name of the image file is set to be a file number=0001, and the image file is stored in the new image folder in the memory 14 (or the storage device 19).

In this way, it is automatically determined whether an image file is stored in an existing image folder or a new image folder is prepared, in accordance with a date and time range (one day, one week, one month, or the like) designated by the user, an image folder is prepared as needed, and the image file is stored in the image folder. As a result, it is possible to easily carry out a preparation of an image folder and a management of an image file in accordance with a use situation.

(Comparison of Set Date and Time Range (Including Settling Date and Time) and Date and Time of Preparing Image Folder: FIG. 8)

Moreover, as shown in FIG. 8, a settling date and time can be included in comparison processing of date and time according to the invention. Namely, by selecting a settling date and time and the date, it is possible to designate a data and time range, not only daily, but also weekly, monthly, and the like. An image folder is updated daily from 3:00 AM to 3:00 AM on the following day in FIG. 8A; is updated weekly from 3:00 AM on Sunday to 3:00 AM on Sunday of the following week in FIG. 8B; and is updated monthly from 3:00 AM on the 1^{st} to 3:00 AM on the 1^{st} of the following month. Comparison processing in a case of including a settlement data and time is, for example, as follows.

Namely, when a date and time T1 of preparing the image file is 02:00 on the 10^{th} of September, the settlement time is 03:00 as shown in FIG. 8. Consequently, a start date and time T3 is 03:00 on the 9^{th} of September, and an end date and time T4 is 03:00 on the 10^{th} of September.

On the other hand, when a date and time T1 of preparing the image file is 04:00 on the 10^{th} of September, the settling date and time is 03:00 as shown in FIG. 8. Consequently, a start date and time T3 is 03:00 on the 10^{th} of September, and an end date and time T4 is 03:00 on the 11^{th} of September.

Accordingly, when a date and time of preparing an existing image folder is 12:00 on 9^{th} of September, in a case of the former, a new image folder is not prepared because it is determined that the date and time is included in the date and time range, while in a case of the latter, a new image folder is prepared because it is determined that the date and time is not included in the date and time range.

In this way, by setting a settling date and time, it is not that it is determined whether or not an image folder is prepared on the basis of only a date, but it can be automatically determined whether or not an image folder is prepared on the basis of a common-sense management time (settling date and time) of an image folder, and an image folder can be prepared.

Further, the comparison processing in the flowchart of FIG. 6 may be expressed such that, as shown in step S31 of the flowchart of FIG. 9, for example, it is determined whether or not an interval between a date and time information T1 of preparing an image file and a date and time of preparing the latest image folder is greater than a predetermined period set on the setting screen of FIG. 7 in accordance with whether or not the predetermined period has passed. In the same way, when the predetermined period has passed, it is determined that the image folder is an old image folder, and an image folder is newly prepared on and after step S21.

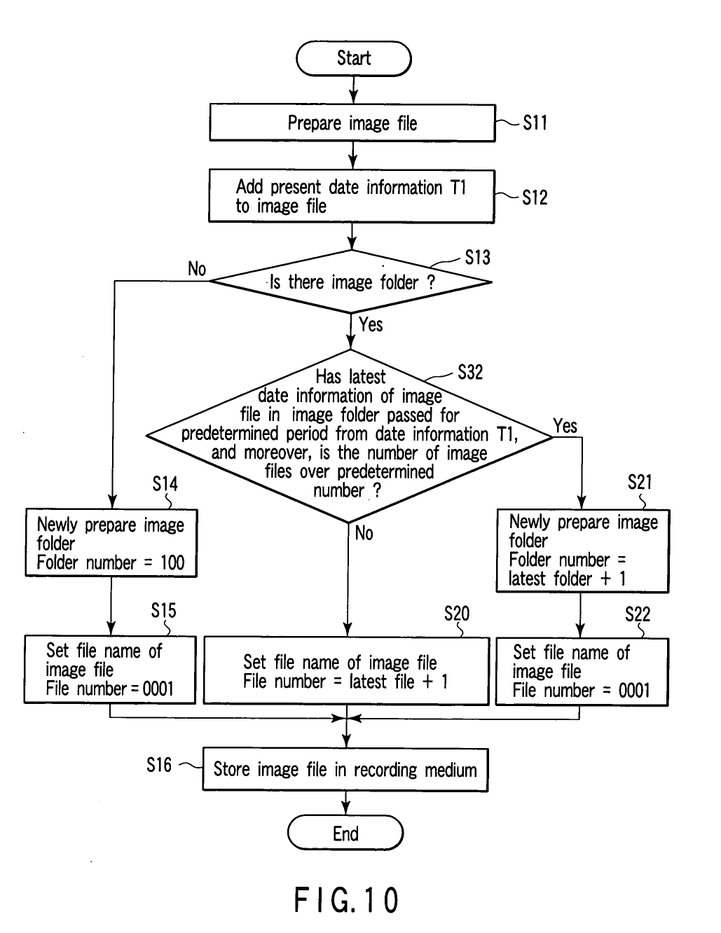

(Comparison of Preparation Date and Time among a Plurality of Image Files: FIG. 10)

Furthermore, in the image folder preparation processing of the image pickup apparatus 1 according to the invention, as shown in the flowchart of FIG. 10, in step S32, it is preferably determined whether or not an image folder is prepared in accordance with whether or not the latest date information of the image file in an existing image folder has passed for a predetermined period from the date information T1 photographed so as to be an image file at the present time. In accordance therewith, many types of image files can be easily classified.

Furthermore, it is preferable to add as a condition at the time of preparing an image folder that it is determined whether or not a number of image files in the existing image folder is over a predetermined number. In this way, by adding a limitation to a number of image files (for example, three or more), a defect in which many image folders are prepared in comparison with a little number of image files, or the like, can be avoided.

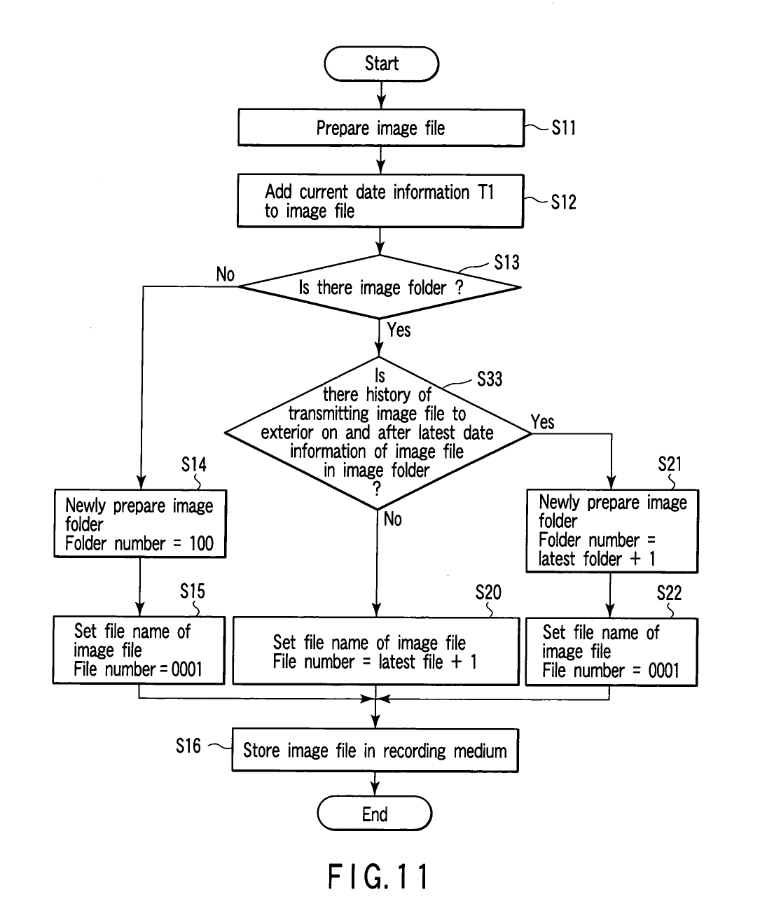

(Transmission Histories of Image Files: FIG. 11)

Furthermore, the image folder preparation processing of the image pickup apparatus 1 according to the invention is, as shown in the flowchart of FIG. 11, in step S33, to inquire whether or not there is a history of transmitting an image file to the exterior on and after a date and time of preparing the latest image file in an existing image folder. Note that the image file transmission history information is stored in, for example, the CPU 18. In this way, the fact that there is an image file transmission history on and after the date and time of preparing the latest image file in an existing image folder means that there is a high possibility that the photographing has been carried out thereafter in a situation different from that of the photographing of the image folder. Therefore, it is determined that a new image folder should be prepared. Consequently, the management of an image folder in accordance with a practical photographing situation can be carried out.

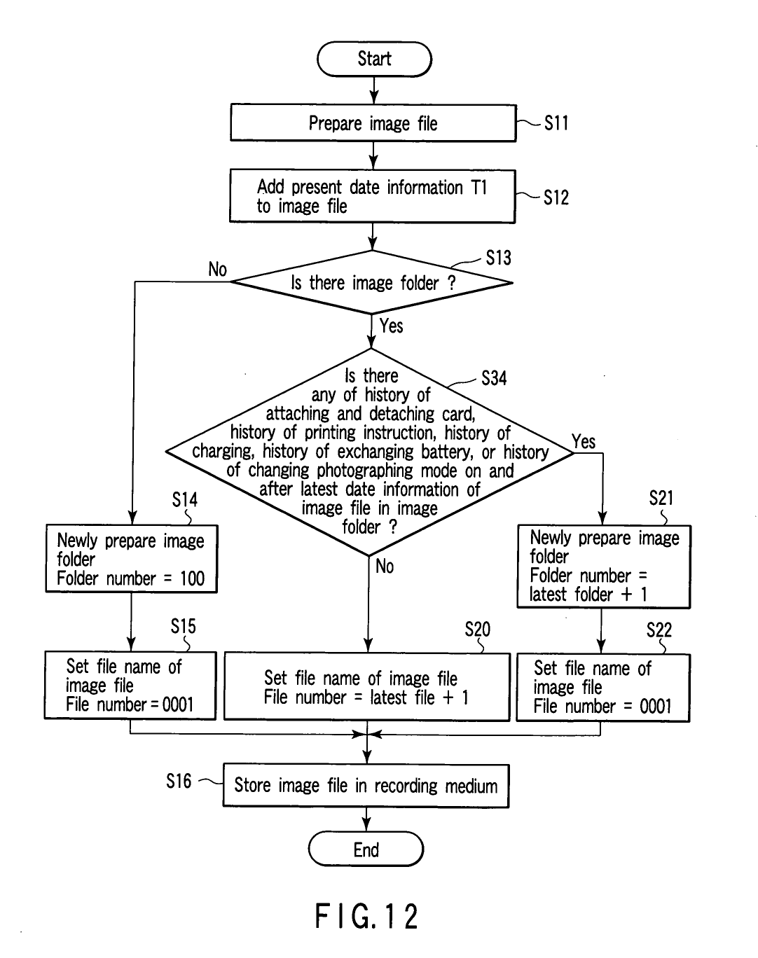

(Transmission History of Image Files: FIG. 12)

Furthermore, the image folder preparation processing of the image pickup apparatus 1 according to the invention is, as shown in the flowchart of FIG. 12, in step S34, to inquire whether or not there is a history of attaching and detaching the memory card 14 or the like, a history of instructing to print the image file, a history of charging a rechargeable battery which is a power source (not shown) of the image pickup apparatus 1, a history of exchanging the rechargeable battery which is a power source (not shown) of the image pickup apparatus 1, or a history of changing a photographing mode, such as a portrait mode or a landscape mode, on and after the date and time of preparing the latest image file in an existing image folder. It is determined whether or not a new image folder must be prepared in accordance with whether or not there is one of those histories in, for example, the CPU 18. There is no necessarily need to inquire the presence or absence of all of those history information, and it is possible for a user to arbitrarily set it in accordance with a use situation.

Namely, among the presence or absence of those history information, for example, only a history of charging can be set as a condition from the menu screen. Further, by combining a plurality of those history information, a combination can be set in accordance with an AND condition, or simply as an OR condition.

In this way, by arbitrarily setting a condition for preparing an image folder in accordance with an actual use situation of the image pickup apparatus 1, an image folder is automatically prepared in a timing for which a user really wishes. In accordance therewith, a user unconsciously merely releases a shutter with respect to an object, which results in many image files being managed under image folders in a most desired state, and the many image files being automatically stored on, for example, a storage region of the memory 14 or a storage region of the storage device 19 which is a mass storage memory or a hard disk driver.

As described above, in the image pickup apparatus which is the embodiment according to the invention described above, a user arbitrarily sets the relationship between a date and time and an image folder, which enables the user to arbitrarily set a date and time interval such as, for example, not only one folder per one day, but also one folder per three days, one folder per one week, or the like.

Accordingly, it is possible to adjust in accordance with a use situation that, when a user wishes to frequently classify image files, a date and time interval is set to be short, and when the image files are hardly used, a date and time interval is set to be long such as one week or the like. Consequently, it is possible to automatically and easily manage image files in accordance with a use situation.

Further, by automatically preparing an image folder in accordance with, not only a period, but also various management information or history information, it is possible to manage and operate image files in accordance with many use situations.

In accordance with the various embodiments described above, those skilled in the art can realize the present invention. However, it is easy for those skilled in the art to further conceive of various modified examples of these embodiments, and the invention can be applied to various embodiments without inventive ability. Accordingly, the invention extends over a broad range which does not contradict the disclosed principles and the novel features, and is not limited to the embodiments described above.

What is claimed is:

1. An image pickup apparatus comprising:
a preparation unit configured to photograph an object, and to prepare an image file with a preparation date and time in accordance with image information of the object;
a recording unit configured to have a recording region; and
a control unit configured to control so as to: detect a preparation date and time of an image folder prepared within the recording region; newly prepare an image folder within the recording region of the recording unit when a period from the preparation date and time of the image file to the preparation date and time of the image folder is longer than a date and time interval set in advance; and store the image file prepared at the preparation unit under the folder.

2. The image pickup apparatus according to claim 1, wherein, at the time of determining the date and time interval, the control unit determines the date and time interval in accordance with a settling date and time set by a user.

3. The image pickup apparatus according to claim 1, further comprising:
a display unit configured to display a screen for setting the date and time range.

4. An image pickup apparatus comprising:
a preparation unit configured to photograph an object, and to prepare an image file with a preparation date and time in accordance with image information of the object;
a recording unit configured to have a recording region; and
a control unit configured to control so as to: detect a preparation date and time of an image file included in an image folder prepared within the recording region; newly prepare an image folder within the recording region of the recording unit when a period from the preparation date and time of the image file prepared at the preparation unit to the preparation date and time of the image file in the image folder is longer than a date and time interval set in advance; and store the image file prepared at the preparation unit under the folder.

5. The image pickup apparatus according to claim 4, wherein, when the number of the image files included in the image folder is greater than or equal to a predetermined number, the control unit determines to prepare the new image folder.

6. An image pickup apparatus comprising:
a preparation unit configured to photograph an object, and to prepare an image file with a preparation date and time in accordance with image information of the object;
a recording unit configured to have a recording region; and
a control unit configured to control so as to: detect a preparation date and time of a latest image file in an image folder prepared within the recording region; newly prepare an image folder within the recording region of the recording unit in accordance with a determination based on history information of operations of the image pickup apparatus on and after the preparation date and time; and store the image file prepared at the preparation unit under the folder.

7. The image pickup apparatus according to claim 6, wherein, when there is a history of transmitting an image file, or when there is a history of attaching and detaching a memory device which is attachable to and detachable from the image pickup apparatus on and after the preparation date and time of the latest image file in the prepared image folder, the control unit controls so as to newly prepare an image folder, and to store the image file prepared at the preparation unit in the image folder.

8. The image pickup apparatus according to claim 6, wherein, when there is a history of instructing to print an image file on and after the preparation date and time of the latest image file in the prepared image folder, the control unit controls so as to newly prepare an image folder, and to store the image file prepared at the preparation unit in the image folder.

9. The image pickup apparatus according to claim 6, wherein, when there is a history of charging a rechargeable battery of the image pickup apparatus, or a history of exchanging the battery on and after the preparation date and time of the latest image file in the prepared image folder, the control unit controls so as to newly prepare an image folder, and to store the image file prepared at the preparation unit in the image folder.

10. The image pickup apparatus according to claim 6, wherein, when there is a change history of changing a photographing mode for photographing of the preparation unit on and after the preparation date and time of the latest image file in the prepared image folder, the control unit controls so as to newly prepare an image folder, and to store the image file prepared at the preparation unit in the image folder.

11. An image pickup method comprising:
photographing an object, and preparing an image file with a preparation date and time in accordance with image information of the object; and
controlling so as to detect a preparation date and time of an image folder prepared within the recording region; to newly prepare an image folder within the recording region when a period from the preparation date and time of the image file to the preparation date and time of the image folder is longer than a date and time interval set in advance; and to store the image file under the image file.

12. The image pickup method according to claim 11, wherein, at the time of determining the date and time interval, the date and time interval is determined in accordance with a settling date and time set by a user.

13. The image pickup method according to claim 11, wherein a screed for setting the date and time range is displayed.

14. An image pickup method comprising:
photographing an object, and preparing an image file with a preparation date and time in accordance with image information of the object; and
controlling so as to detect a preparation date and time of an image file included in an image folder prepared within the recording region; to newly prepare an image folder within the recording region when a period from the preparation date and time of the prepared image file to the preparation date and time of the image file in the image folder is longer than a date and time interval set in advance; and to store the prepared image file under the folder.

15. The image pickup method according to claim 11, wherein, when the number of the image files included in the image folder is greater than or equal to a predetermined number, the method determines to prepare the new image folder.

16. An image pickup method comprising:
photographing an object, and preparing an image file with a preparation date and time in accordance with image information of the object; and
controlling so as to detect a preparation date and time of a latest image file in an image folder prepared within the recording region; to newly prepare an image folder within the recording region in accordance with a determination based on history information of operations of the image pickup apparatus on and after the preparation data and time; and to store the image file under the image folder.

17. The image pickup method according to claim 16, wherein, when there is a history of transmitting an image file, or when there is a history of attaching and detaching a memory device which is attachable to and detachable from the image pickup apparatus on and after the preparation date and time of the latest image file in the prepared image folder, the method controls so as to newly prepare an image folder, and to store the prepared image file in the image folder.

18. The image pickup method according to claim 16, wherein, when there is a history of instructing to print an image file on and after the preparation date and time of the latest image file in the prepared image folder, the method controls so as to newly prepare an image folder, and to store the prepared image in the image folder.

19. The image pickup method according to claim 16, wherein, when there is a history of charging a rechargeable battery of the image pickup apparatus, or a history of exchanging the battery on and after the preparation date and time of the latest image file in the prepared image folder, the method controls so as to newly prepare an image folder, and to store the prepared image file in the image folder.

20. The image pickup method according to claim 16, wherein, when there is a change history of changing a photographing mode for the photographing on and after the preparation date and time of the latest image file in the prepared image folder, the method controls so as to newly prepare an image folder, and to store the prepared image file in the image folder.
